(19) United States
(12) Patent Application Publication
(10) Pub. No.: US 2012/0216133 A1
(43) Pub. Date: Aug. 23, 2012

(54) SECURE CLOUD COMPUTING SYSTEM AND METHOD

(75) Inventors: Jeremy Barker, Wiltshire (GB); Rhys Newman, Oxon (GB); Edward Macnair, Hants (GB)

(73) Assignee: OVERTIS GROUP LIMITED, Oxfordshire (GB)

(21) Appl. No.: 13/214,616

(22) Filed: Aug. 22, 2011

Related U.S. Application Data
(60) Provisional application No. 61/375,621, filed on Aug. 20, 2010.

(51) Int. Cl. G06F 3/01; G06F 15/16

(52) U.S. Cl. 715/760

(57) ABSTRACT

A system and method, comprising: an interface port to a data communication network; a processor and associated memory, configured to execute a content browser, and a browser plugin, the browser plugin filtering at least a portion of data received by the content browser, and at least one of selectively blocking, modifying, or permitting interaction of a user with the received data, in dependence on at least a user-associated configuration file received from a remote resource through the interface port, and communicating at least one item of information which is blocked from access by the user; and a display port, configured to output information defining a user presentation of browser output. Communications between the remote resource and the plugin or browser may be encrypted. For example, the plugin receives user login information from the remote resource, and automatically fills in a login page for an Internet resource, while preventing user-access to the login information itself.

### FIELD OF THE INVENTION

The present invention relates to “cloud” computing and, more particularly, to securing resources deployed within a “cloud” network.

### DESCRIPTION OF THE RELATED ART

Network browsers (browsers), such as Firefox or Microsoft Explorer, allow users of client machines to request and retrieve resources from remotely located server machines via the Internet. These network browsers can display or render HyperText Markup Language (HTML and other code form) documents provided by the remotely located server machines.

Additionally, browsers are able to execute script programs embedded in the HTML or other code form documents to provide some local functionality. Functionality provided as a result of events generated by the code form documents is typically referred to as functionality within the “sandbox” (which can be conceived of as a container within which the HTML or other code of the resource web pages can be loaded and executed with safety within the user's computer) and functionality provided by the browser is typically referred to as within the “chrome” (typical examples being the functions of the user's browser to print, copy and save the contents of the loaded page).

Conventionally, browsers are used to access public networks, such as the Internet and it is known that, to protect web page data traffic between the browser and servers it accesses on public networks, browsers and servers implement Transport Layer Security, also known as Secure Sockets Layer (TLS).

Providers of certain applications used for reading documents, such as PDF documents, support the inclusion of document security information held in the PDF file, to require the software reading the file to present the file such that functions in the reader, such as “Print” or “Save a copy” are disabled and such applications may be implemented as plugins to browsers. These limitations are defined by the document. It is also known that standard browsers can be modified on users' computers such that certain functions of the chrome are disabled (instrumented browser), or indeed that customized browsers can be deployed.

Whereas it is known that conventional business applications, such as customer databases, are secured within private networks normally protected by firewalls so that browsers residing on computing machines outside the private network are not able to gain access to any resources on the private network, unless provided with login via an authentication server or a Virtual Private Network.

However in the cloud, business data, such as customer names, addresses and telephone numbers, are held on servers controlled by the providers of services within the cloud (cloud-based-services), such as a sales support application service.

In the cloud, once a user has obtained access to a particular set of cloud-based services (resource), while a provider of the resource can implement TLS, to secure the connection to the browser, and assure a degree of access control and limits to functionality that is available to users, for example, by enabling the controller of an account on the resource to set up different user identities within their account and enable or disable different aspects and functions of the resource available to those users, the level of restriction of access and control over what the user can do in the browser that can be practically supported wholly within the resource environment, is limited. Consequently the availability of refined access control, for example, to a prevent one or more specified users or types of user, printing out an entire customer database, other than during office hours while their computer is physically located within certain premises, is not available currently.

Therefore the provider of the resource can only give a limited degree of control to the sandbox within the browser as opposed to the chrome of the user's browser, if the browser is a “standard installation” and not an instrumented browser. For practical purposes endeavouring to ensure control of access to the resource by supplying users only with customized or instrumented browsers immediately defeats the at least some of the benefit of ubiquitous access afforded to organizations by users having access to standard browsers wherever they may be. Therefore the provider of the cloud resource, currently, can only have limited control over the diverse functions the user can invoke relative to the resource web pages, loaded in the sandbox of the standard browser, nor is there a ready means for the user's transactions to be finely, timely and effectively monitored from and in the browser chrome at the point of delivery of the HTML or other code (as opposed to after the event, in an audit trail, for example).

“Single Sign-on” systems exist, embodied either in software alone or as combinations of software and hardware of some kind (e.g. a token key generator), which allow access control to diverse applications and computers to be unified by the User supplying a unique but humanly manageable set of identifiers to the software and/or system. The Single Sign-on software or system then itself automatically manages or assists the user to sign on to all applications and computers to which the user has access identifiers, by supplying those identifiers from within the Single Sign-on software or system. Single Sign-on systems do not, within themselves, have the means at the level of a specific page being viewed by the user to supervise, deny access to or control the use of individual functions and actions available to the individual user, as these are features conventionally held within the configuration data or user profile data of the particular system the user is accessing.

From the perspective of a user of cloud-based services, these short-comings mean that various aspects of fine control, restriction and monitoring of user access and use of resources that were available in comparable conventional computer applications, by means of configuration or user profile data being used to modify the operation of individual applications, are not available. Moreover, through the proprietor's invention disclosed in GB 2,412,805, expressly incorporated herein by reference, the user of conventional applications have a means by which to supervise, deny access to or control the use of individual functions and actions available to the user of a multiplicity of conventional applications within a private network but not in the Cloud. See also, U.S. Pat. No. 7,774,455, US 2009/0138804 and US 2004/0230825, each of which is expressly incorporated herein by reference.

Known single sign-on systems are Cosign, (cosign.sourceforge.net); MyOneLogin (www.myonelogin.com/index.html); Java Open Single Sign-On (www.josso.org); Quest Software (www.quest.com/identity-management/SSO.aspx); Roboform (www.roboform.com); and Sentillion (www.sentillion.com/expresso/index.html), each of which is expressly incorporated herein by reference. Web application securitry solutions are also disclosed in www.outprotect.com/; www.symplified.com (US 2009/0070466); www.siteadvisor.com; www.trendsecure.com/en-US/tools/security_tools/trendprotect; and www.megaproxy.com, each of which is expressly incorporated herein by reference.

Thus, there is a need for improved approaches to providing fully functional secure monitoring, restriction and control over user access to resources maintained in the Cloud.

### SUMMARY AND OBJECTS OF THE INVENTION

The present technology provides improved approaches for providing secure monitoring, restriction and control over user access to resources maintained in the cloud (to be referred to here as “a protected resource”). “Cloud” as used herein refers to web-based applications and services delivered to multiple users connected to the Internet or other computer network. The applications and services being protected by the invention are referred to here as the “Protected Services” and the authorised user of the Protected Services is referred to as the “User”. The secure monitoring and control can be provided through a public or private network or from a public network to a private network using a standard network browser. Multiple remote users are able to gain monitored, restricted and controlled access to and use of at least portions of protected resources, through a browser Plugin, which retrieves requisite access control information and user profile information from a common resource on the network.

The technology can be implemented in numerous ways, including as a system, method, device, and a computer readable medium for controlling a programmable processor to implement the corresponding system and method.

While the preferred implementation is based on a current web browsing technology which provides an application-level browser which accesses data using standard formats and protocols, the invention is not so limited. In particular, the information may be provided through various types of networks, in structured and unstructured forms, according to a variety of standards and proprietary formats.

The technology, in the form of a software adjunct to a browser, may be installed through local computer readable media, or through a network interface. It may also be provided as an intrinsic part of the browser, or as part of an emulated or virtualized interface system.

As a method for accessing a protected resource, one embodiment includes at least: receiving a login request from a user for access to an authentication intermediary server; authenticating the user at the authentication server and downloading user profile data to a module, such as a browser Plugin, to enable the Plugin to access one or more protected resources and to do at least one of: supervise, deny and control the use of individual functions on the protected resource and/or in the browser's own functions (generally referred to here as “controlled functions”); subsequently the user's browser page loads, and resource requests are matched to data in the Plugin user profile. When the Plugin detects events triggered by the code in pages loaded to the browser or the browser's own functions that correspond to controlled functions, those functions and optionally (in the case of an event triggered by page code loaded), relative surrounding page code, are suppressed or modified according to the profile settings. When the Plugin detects a resource request or a controlled function request in the user's browser for an address at a protected resource or a controlled function of the browser, the Plugin, based on the resource request match against the Plugin user profile, determines whether the response should be to allow, deny, modify or control use of the protected resource and/or controlled function and then, accordingly, allowing, preventing, modifying or controlling operation. For example, the Plugin will block or modify a response to the resource request and/or controlled function request when the information in the stored user profile for the user indicates that the user is not permitted to perform the particular operation with the protected resource related to the resource request and/or the controlled function. As discussed above, this technology is preferably implemented within the browser, but can also be implemented outside of a browser, for example as a separate application, within an operating system, as a local server under the same operating system, a proxy server (local or remote), a router or processor within a communications infrastructure, etc. The user's browser (including plugin) may detect an event requiring certain parts of web pages loaded from the resource to be decrypted, for example fields in the form and the descriptors of those fields; and/or detect an event request that requires data from the web page or the user's computer to be encrypted before it is provided to the resource, for example a ZIP code, full name, date of birth. The plugin may lock the user interface to prevent execution of applications and introduction of devices to the user's computer, any of which would undermine the security. The system may also provide secure communications (e.g., encrypted communications) which are only decrypted within the plugin, and blocked from access by other applications outside the browser, or even other plugins within the same browser environment. As an alternative to preventing access, if the user profile information indicates that warning and/or monitoring is required, the system may issue a warning and/or collect monitoring information from the user's browser and/or computer relative to events occurring before, on and after the operation and/or function requested by the user and passing the collected information to the server.

Preferably, the information to be protected is communicated in encrypted form, and thus not accessible except to the authorized Plugin. The Plugin may, on one hand, prevent unauthorized processes from executing on the client computer, and employ operating system resources to receive, manage, display, and process the received information. On the other hand, the Plugin may itself receive the encrypted information, and isolate that information from access and use by unauthorized tasks or applications on the computer. Of course, other architectures are also possible.

According to one embodiment, a web service application is provided which intermediates between the User and the Protected Services. The application controls, by the secure means, the User's access to resources and or applications in the “Cloud” on one or more servers in diverse locations. The security application is, for example, implemented by a browser “plug in” which is, for example, downloaded from a controlled server, to the User's computer and installed to operate within and/or in conjunction with a browser. The Plug-in is preferably embedded with the addresses of the Authentication Server, defined below. The application allows the Protected Services to be configured such that the User will at any time not know the full identifiers required to access the User's Protected Services as the User's identifiers to access the Protected Services are downloaded to the Plug-in only on successful login to the Authentication server, thereby ensuring that only browsers with the Plug-in installed and a User who has successfully authenticated themselves may be able to access the Protected Services.

To provide the User with secure data entry into, and retrieval from one or more fields in the Protected Services, encryption and decryption of such data may be provided within the Plug-in, and the keys corresponding to the User's identifiers held in the Authentication Server. One benefit of this aspect is that it allows the User (and perhaps the User's employer) to secure such data for compliance with laws of the User's jurisdiction regardless of the user of Protected Services in the “Cloud” that may be provided from servers outside the User's jurisdiction, for example, adequate security for personal data under the UK Data Protection Act where personal data is being held on a computer in the United States.

The secure application obtains identifiers for all Protected Services which are held in a secure server, which responds to requests only from the Authentication Server, by a method similar to traditional “single sign-on”. The full identifiers are not transmitted in a form that is readily comprehensible at the User's end point at any time, and may be protected by means of “on the fly” encryption and communication with the Protected Services using a secure link. For example, standard, browser-provided, link encryption such as SSL (TLS) may be used.

The system is configured to avoid storing secured information in:
hardware that the user must use (e.g. a dedicated computer that must be the user's terminal, a dongle or a passcard that the user must have with them), although the secure application may be supplemented by and integrated with additional items of such kind; the benefit of avoiding any hardware implementation is to allow the user to access the resource from a diversity of end points, the only requirement being that the necessary Plugin has been downloaded and installed to the browser;
any file containing the user's identifiers for the resource or the Authentication Server saved to storage media; the benefit of this being to foil attempts by spyware to derive the identifiers and circumvent the secure means;
the servers hosting the resource (e.g. access control identities and passwords held on a web service server); one significant benefit of avoiding this aspect of the secure application co-residing with the resource servers is that the controller of the resource can achieve locally required information assurance standards and compliance with legislation in its own jurisdiction without requiring the provider of the resource to locate the resource in its own jurisdiction (for example, data that is covered by privacy laws which may not be transferred outside the originating jurisdiction unless it is secure);

A server (“Authentication Server”), preferably situated in a physically secure location, provides verification of the user's identity and, upon successful authentication, permits download of the user's access control identifiers as well as information defining the current unique resource locator (URL) lexicon for the resource to the Plugin for the resource, together with data comprising a profile of the user's access restrictions to the resource; a benefit of the Authentication Server, apart from the security afforded to the user's identifiers on the resource, is that authentication data for the resource (and any encryption keys for data encrypted by the Plugin on the resource) can be located independently of the control of the resource servers, (e.g. within the jurisdiction of the user or the controller of the account on the resource).

For display of access control information, URLs and/or pages from the resource may be suppressed through the Plug-in managing each web page loading event, for example display of any resource password change page to the user (as well as “Post” commands and the like from the user's browser), so that the user is unable to manipulate, view or intercept any communications traffic relating to the access control to the resource.

The Plug-in managing each web page loading event, may suppress or modify the display of URLs and/or features of the loaded page that relate to resources to which the user has no, restricted or monitored access according to the loaded user profile data.

The Plug-in may also deny, modify or otherwise invoke actions prior to executing “Post” or “Get” events resulting from the user's interaction with the loaded page and/or the browser, dependent on the user's loaded profile in the Plug-in and such other information relative to the user's location, time of action and verification of identity, as the Plug-in may be configured to derive from the user's computer, other computers, users and/or connected devices.

In addition to the features described above, a typical embodiment will:
Securely manage the user's access control on the Authentication Server to provide the usual range of access control management services (creation and removal of users, change of passwords, selection of elements of the resource available to the user etc);
Support migrating from, or slaving to, the user's existing access control profile (within a conventional networked Client/Server environment), a known LDAP type server to the Authentication Server thereby providing a replication of the same access control within the cloud;
“Learning” by example, the user's access control profile, for example by an Administrator visiting the user's resource pages and designating the elements of the resource that cannot be accessed by the user or are otherwise controlled or on the user's first access to the resource, determining which links, buttons or other visual features of the resource have controlled access of one kind or another and storing these to the user's profile, and thereafter presenting those features in an appropriate visual manner;
Recording audit information (which may include: authentication events, images from cameras, time information, status, location, connection and disconnection events for devices and users) in relation to the user's activities with regard to the resource and for other events in the “chrome” of the browser or on the users computer or connected devices and systems and maintain a log of this information; and
Forwarding to a known server on the controlling organisation's network, the above audit information to the server's log.

### BRIEF DESCRIPTION OF THE DRAWINGS

FIG. 1 shows a schematic diagram of a system according to the present invention;

FIG. 2 shows a flowchart of a Web Page Loaded Event;

FIG. 3 shows a flowchart of an HTTP Request Event;

FIG. 4 shows a flowchart of a login HTTP Request Event; and

FIG. 5 shows a schematic diagram of a system according to the present invention.

### DETAILED DESCRIPTION OF THE PREFERRED EMBODIMENTS

A computer executable program, and computer executing the program, is provided for auditing and securing browser based web/cloud applications. It achieves this by inserting a “user action filter” between the user and the webpage, recording user actions and blocking the use of certain webpage controls (buttons, hyperlinks, etc) based on user profile and user group membership. The system operates by installing a browser plugin and associated code, and may operate cooperatively or independently with the data sources to be secured. For example, a preferred embodiment provides a client system build using JavaScript/Java/.NET/C++ Browser Plug-in's, and a server system built with Java/.NET/MySql Server, for configuration and audit trail.

The Browser Plug-in may provide a learning mode, in which a visual programming paradigm (graphic user interface) is provided for defining a user profile. Web pages/applications are secured based on the “learnt” user profile. The system may also provide automated, secure web application logon (combined with 3rd party password entry suppression).

The server component is configured to store “learnt” user profile configurations, retrieve user group names from LDAP servers (e.g. MS Active Directory), record user action audit trails, and optionally, forward audit trail entries to networked servers

The system is able to “protect” selected webpage functions, on at least a user by user basis, without altering the original web site/web application. Further protection may be dependent on, for example, time, location, device connection status, presence or absence of other users, security status, the origin and destination of any event comprising the intended transfer of any data in or from the user's browser or computer. This independent protection mechanism allows organizations to enforce tight, granular control of web based applications such as salesforce.com, Oracle Apps, SAP, etc.

A summary of the process is as follows:

Users are registered on the server (username and password) and assigned to relevant user groups (which can be created as necessary). Accounts and passwords on the web applications to be secured are created. The web application authentication details (usernames and passwords) are stored on the server against the corresponding user registration details. A supervisor uses a browser, with a special plug-in installed and in “Learning Mode”, to:

Identify the logon authentication fields for the web application and password change URL and fields (these are stored on the server and used later by the plug-in to automatically log the user on to the web application and prevent modification of user logins)

Identify web page controls to be “protected” by assigning “controlled” user groups to that control. The control details are stored on the server and used later by the plug-in, when it is “Protection Mode”, to automatically record, block and/or display a message when the control is used (as determined by user group membership).

The control details and action options include:
Web control identification, details (e.g. name, type, inner html)
Main action options: Record, Block, Encrypt, Display Message.
The options may also include tick boxes for other “non-visual” configuration options such as:
Blocking/recording browser “Print”, “Cut”, “Copy” menu options;
Recording “Logon”, “Logoff”, “Print Screen” activity;

The supervisor can also inspect and analyze audit trails recorded on the server. Audit trail entries can be formatted, in a notification format, and forwarded to networked servers

If necessary, the user downloads and installs the browser plug-in, as the plug-in is the only way the user can gain access to the web application account provided by the business or organization.

When the browser is loaded the plug-in prompts the user for their username and password. The plug-in authenticates the user's credentials with server and, if successful, uploads any associated user profiles i.e. web application authentication details, user group memberships and protected control identification details.

When a user browses to a web application logon page, recognized by the plug-in, the plug-in asks the user what authentication profile to use to log onto the web application (if the user has been assigned multiple accounts) or allow the user to log on the web application for personal use.

As web application web pages are loaded, the controls on the web page are indentified and checked against the users profile and, if found, the appropriate action is can be taken e.g. disable (grayed out) or hidden. Alternately, or in addition, as the user uses the controls of the web application they are indentified and checked against the users profile and, if found, the appropriate action is taken e.g. record or block. Further, “HTTP Posts” or “Gets” may be intercepted by the control.

Encryption in this context means on-the-fly encryption of field data such that is encrypted prior to transmission to, and storage on, the server and decrypted within the browser (e.g., the plugin) upon retrieval from the server. In this way the ownership of encryption keys stay with the Web subscriber and not with the owners of the server storing the data.

The logon authentication fields for the web application are stored on the server and used later by the plug-in to automatically log the user on to the web application. Web page controls to be “protected” are identified by assigning “controlled” user groups to that control. The control details are stored on the server and used later by the plug-in, when it is “Protection Mode”, to automatically record, block and/or display a message when the control is used (as determined by user group membership).

The “Learning Mode” is engaged by using a plug-in popup menu and entering a supervisor password. When logging on to target web applications the plug-in records the username and password fields, which are indentified to the plug-in, so that it can provide the logon password for the subsequent logons to prevent “unprotected” access i.e. the plug-in must be present to logon to the web application.

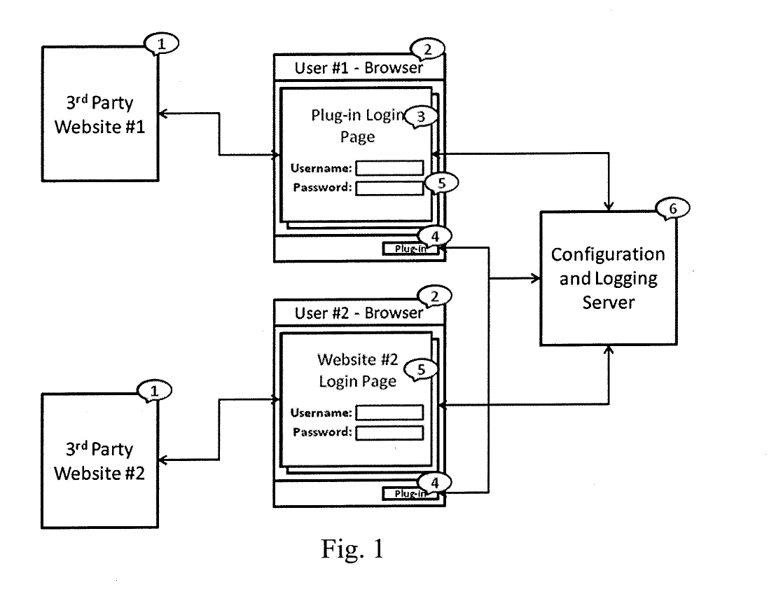

FIG. 1 shows one or more websites providing the resources (cloud applications) to be “managed”, which are accessed by one or more users' browsers in which a Plugin has been loaded, which is configured to address an Authentication Server. The login pages (and subsequent pages) are requested from the resources, and the Plugin matches the URLs against the configuration and identifier information downloaded by the Plugin from the Authentication Server. The login page is typically supplanted by a login page provided by the Plugin, in which the user supplies identifiers only verifiable in the Authentication server (and not in the resource) and the Plugin logs the user into the resource without revealing the URL and/or identifiers used for that purpose. Subsequent pages served by, and requests to access, the resource by the user are managed within the Plugin. Where desired, audit information is transmitted from the Plugin to the Authentication Server (performing a logging function).

In FIG. 1, Third party website 1 (cloud application) to be “managed” at the endpoint (browser) e.g. salesforce.com, sap.com, etc. is called through the User's web browser 2, e.g., Internet Explorer, Firefox, Google Chrome, etc. The Web Login Page 3, served from Web Server 6, is used to authenticate access to the Web System. A Plug-in 4 is typically installed in the User Web Browser (2) by the user or IT department, if it is not already present and available. A 3^{rd} Party Website Login Page 5 is communicated through the network (e.g., Internet), to the Browser 2, and is intercepted and optionally blocked or modified or filled in, before display to the User by the Plug-in 4. The Plug-in 4 communicates with the Web (Configuration and Logging) Server 6.

Web System administrators can create profiles for users of 3^{rd} Party Web Websites 1 to control, or record, access to specific functions within the website. A user logs typically onto the Web Browser Plug-in 4 using a Login Page 3 which is served from the Web Server 6. The Web Server 6 provides the Web Browser Plug-in 4 with the profile for the authenticated user (previously configured and stored on the Web Server 6, including, for example:
1. Third party website authentication details;
2. Web pages to be blocked (based on URL match); and
3. Web form controls to be disabled, concealed or encrypted.

When the user browses to the 3^{rd} Party Website 1 Login Page 5, the Web Plug-in 4 may be programmed (based on the User profile, etc.) to automatically login the user on the 3^{rd} Party Website 1 such that the user is not, or need not be, aware of the login credentials used. This means that, absent external communication of login details, the user cannot bypass the Web System by accessing the 3^{rd} Party Website 1 account by using a web browser that does not have the Web Plug-in 4 installed. As the user browses pages with the 3^{rd} Party Website 1, the Web Plug-in 4 blocks prohibited web pages, and also disables or conceals specific web page controls

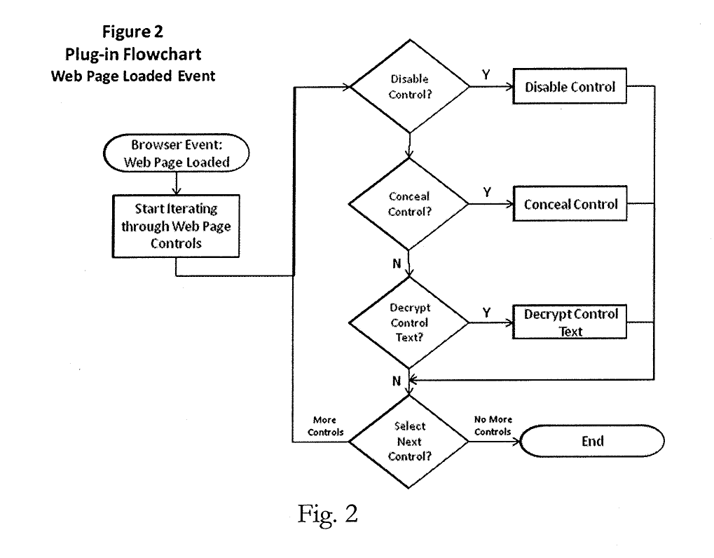

FIG. 2 shows a flowchart of a Web Page Loaded Event. As a page is loaded in the sandbox of the browser from the resource, events corresponding to controls and fields are iterated through the Plugin. The Plugin tests each control and field against configuration information loaded in the Plugin, to determine whether it is: shown as disabled on the page viewed by the user; concealed in the page viewed by the user and (in the case of encrypted fields) decrypted by the Plugin before display to the user.

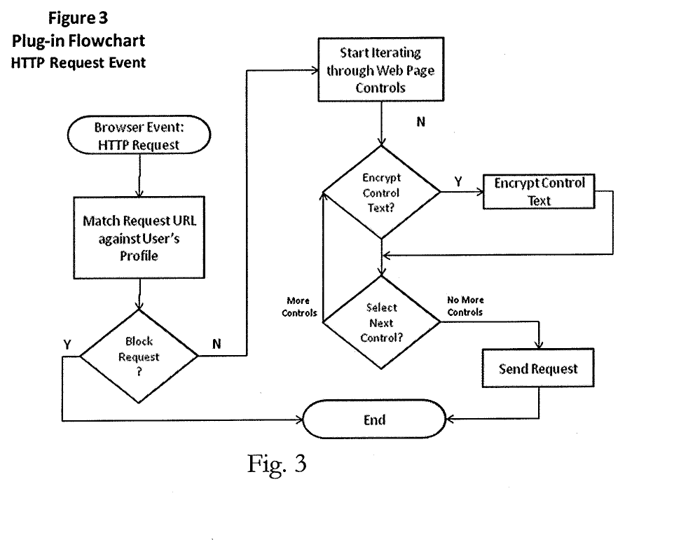

FIG. 3 shows a flowchart of an HTTP Request Event. As a request (for a “Post” or “Get”) is made in the browser (HTTP Request), if the HTTP Request is matched against the configuration information loaded in the Plugin, the Plugin determines whether to block or allow the HTTP Request, and, if allowed, iterates through the web page controls and fields to determine whether they are to be encrypted before sending to the resource.

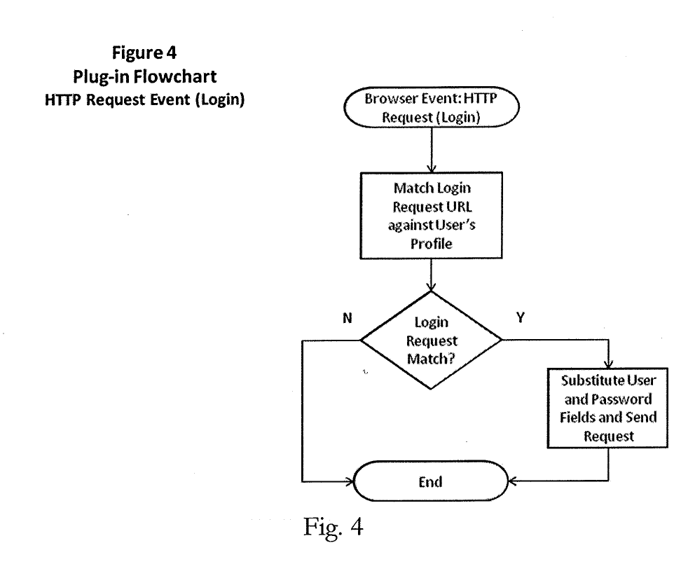

FIG. 4 shows a flowchart of a login HTTP Request Event. As a request is made in the browser for a login (Login Request), if the Login Request is matched against the configuration information loaded in the Plugin, the Plugin substitutes User and Password and any other information and sends the modified login request to the resource.

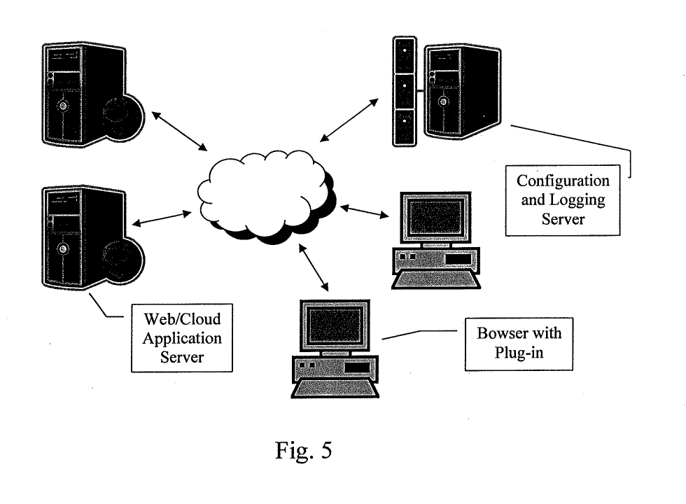

FIG. 5 shows a schematic diagram of a system according to the present invention, in which user computers, having Internet browsers access remote servers through the Internet. The browsers have plugins which communicate with a remote configuration and logging server.

What is claimed is:

1. A system, comprising:
an interface port to a data communication network;
a processor and associated memory, configured to execute a content browser, and a browser plugin, the browser plugin filtering at least a portion of data received by the content browser, and at least one of selectively blocking, modifying, or permitting interaction of a user with the received data, in dependence on at least a user-associated configuration file received from a remote resource through the interface port, and communicating at least one item of information which is blocked from access by the user; and
a display port, configured to output information defining a user presentation of browser output.
